(19) United States
(12) Patent Application Publication
(10) Pub. No.: US 2026/0091377 A1
(43) Pub. Date: Apr. 2, 2026

(54) METHODS OF MAKING CATALYSTS SUITABLE FOR HYDROCRACKING

(71) Applicants: Saudi Arabian Oil Company, Dhahran (SA); JGC Catalysts and Chemicals Ltd., Kawasaki (JP)

(72) Inventors: Omer Refa Koseoglu, Dhahran (SA); Robert Peter Hodgkins, Dhahran (SA); Hiroyuki Seki, Kawasaki (JP); Shigeyuki Nagano, Kawasaki (JP); Koji Uchida, Fukuoka (JP)

(73) Assignees: Saudi Arabian Oil Company, Dhahran (SA); JGC Catalysts and Chemicals Ltd., Kawasaki (JP)

(21) Appl. No.: 18/904,567

(22) Filed: Oct. 2, 2024

(51) Int. Cl. B01J 29/16; B01J 29/08; B01J 33/00; B01J 35/30; B01J 35/45; B01J 35/61; B01J 35/63; B01J 37/08; B01J 37/30; C01B 39/02; C01B 39/24; C10G 47/20

(52) U.S. Cl. CPC B01J 29/166; B01J 29/088; B01J 33/00; B01J 35/393; B01J 35/45; B01J 35/617; B01J 35/633; B01J 35/635; B01J 37/08; B01J 37/30; C01B 39/026; C01B 39/24; C10G 47/20; B01J 2229/183; B01J 2229/20; B01J 2229/24; C10G 2300/1074

(57) ABSTRACT

A method of making a catalyst suitable for hydrocracking may comprise: contacting an initial catalyst with a passivation agent to form a passivated catalyst, contacting the passivated catalyst with a metal precursor to form a doped catalyst, and heating the doped catalyst to form the catalyst. The initial catalyst may comprise acid sites, wherein the passivation agent binds to a portion or all of the acid sites on the initial catalyst.

### FIELD

The present disclosure generally relates to catalysts, and more specifically to methods of making catalysts suitable for hydrocracking.

### BACKGROUND

Hydrocracking is a versatile catalytic process that converts heavy oils to lighter products by aromatic saturation, cracking, and isomerization reactions in the presence of hydrogen. These hydrocracking treatments require catalysts which can at least partially crack the large molecules present in the heavy oils. Conventional catalysts may have poor cracking conversion. Accordingly, new methods of making catalysts suitable for hydrocracking with various improved attributes are needed.

### SUMMARY

There is a need for methods of making catalysts with, in some embodiments, improved selectivity and/or efficiency for hydrocracking. Presently discovered, and included in the embodiments described herein, are methods of making catalysts suitable for hydrocracking that include contacting an initial catalyst with a passivation agent to form a passivated catalyst, wherein the initial catalyst comprises acid sites, and wherein the passivation agent binds to a portion or all of the acid sites on the initial catalyst. Such methods, utilizing a passivating agent, it has been discovered, may provide for improved selectivity and/or efficiency in produced catalysts as compared with those made by conventional processes.

According to one or more embodiments, a method of making a catalyst suitable for hydrocracking, the method comprising: contacting an initial catalyst with a passivation agent to form a passivated catalyst, wherein the initial catalyst comprises acid sites, and wherein the passivation agent binds to a portion or all of the acid sites on the initial catalyst; contacting the passivated catalyst with a metal precursor to form a doped catalyst, wherein the metal precursor comprises one or more metals, one or more metal salts, or both, the one or more metals, one or more metal salts, or combinations thereof comprising cobalt atoms, molybdenum atoms, nickel atoms, tungsten atoms, or combinations thereof; and heating the doped catalyst to form the catalyst, wherein: the catalyst comprises from 19.9 wt. % to 97.9 wt. % of a support material; from 2 wt. % to 80 wt. % of a zeolitic material comprising a microporous framework, wherein the microporous framework comprises zirconium oxide and titanium oxide; and from 0.1 wt. % to 40 wt. % of one or more metals, one or more metal oxides, or both, wherein the one or more metals are chosen from cobalt atoms, molybdenum atoms, nickel atoms, tungsten atoms, or combinations thereof, wherein the one or more metal oxides are chosen from cobalt oxide, molybdenum oxide, nickel oxide, tungsten oxide, or combinations thereof, and wherein the one or more metals, the one or more metal oxides, or both, are disposed on the microporous framework, the support material, or both.

This summary is provided to introduce a selection of concepts that are further described in the detailed description. This summary is not intended to identify key or essential features of the claimed subject matter, nor is it intended to be used as an aid in limiting the scope of the claimed subject matter.

Additional features and advantages of the described embodiments will be set forth in the detailed description that follows. The additional features and advantages of the described embodiments will be, in part, readily apparent to those skilled in the art from that description or recognized by practicing the described embodiments, including the detailed description that follows as well as the claims.

### DETAILED DESCRIPTION

References will now be made in greater detail to various embodiments of catalysts and methods of making the catalysts. The catalysts described herein, according to some embodiments, may be suitable for utilizing in hydrocracking reactions. However, it should be understood that the presently disclosed catalyst may be utilized for other reaction types and/or mechanisms, and their use is not limited herein. As used in this disclosure, a “catalyst” refers to any substance that increases a rate of a chemical reaction, such as a hydrocracking chemical reaction.

According to one or more embodiments, a catalyst may comprise a support material, a zeolitic material comprising a microporous framework, and one or more metals, one or more metal oxides, or both, wherein the one or more metals are chosen from cobalt atoms, molybdenum atoms, nickel atoms, tungsten atoms, or combinations thereof, wherein the one or more metal oxides are chosen from cobalt oxide, molybdenum oxide, nickel oxide, tungsten oxide, or combinations thereof.

In one or more embodiments, wherein when the catalyst is utilized in a hydrocracking reaction to crack vacuum gas oil, the activation energy of the hydrocracking reaction may be less than or equal to 55 Kcal/mol, less than or equal to 50 Kcal/mol, or even less than or equal to 48 Kcal/mol. As described herein, the activation energy of a catalytically driven hydrocracking reaction may be determined by known techniques to those skilled in the art such, without limitation, as utilization of an Arrhenius plot. In one or more embodiments, the vacuum gas oil used to determine the activation energy of the hydrocracking reaction may have an initial boiling point of from 205° C. to 225° C. and a 95 wt. % boiling point of from 555° C. to 575° C. In one or more embodiments, the vacuum gas oil used to determine the activation energy of the hydrocracking reaction may have a 5 wt. % boiling point of from 305° C. to 325° C., a 50 wt. % boiling point of from 430° C. to 450° C., and/or a 70 wt. % boiling point of from 470° C. to 490° C. In one or more embodiments, the vacuum gas oil used to determine the activation energy of the hydrocracking reaction may have a density of from 0.915 g/cc to 0.930 g/cc. In one or more embodiments, the vacuum gas oil used to determine the activation energy of the hydrocracking reaction may include sulfur in an amount of from 2.0 wt. % to 3.0 wt. %. In one or more embodiments, the vacuum gas oil used to determine the activation energy of the hydrocracking reaction may include a concentration of nitrogen of from 500 ppm to 1,500 ppm. In one or more embodiments, a ratio of hydrogen to vacuum gas oil used to determine the activation energy of the hydrocracking reaction may be 1,000 standard liters of hydrogen per liter of vacuum gas oil (StL/L). In one or more embodiments, the hydrogen pressure used to determine the activation energy of the hydrocracking reaction may be 13.5 MPa (137.7 kg/cm²). In one or more embodiments, the LHSV used to determine the activation energy of the hydrocracking reaction may be 0.50 hr⁻¹. In one or more embodiments, the temperature of the hydrocracking reaction used to determine the activation energy of the hydrocracking reaction may be 360° C., 375° C., 390° C., and 405° C. Without intending to be bound by any particular theory, it is believed that the reduction of the activation energy of the hydrocracking reaction may increase an efficiency of the hydrocracking reaction.

In one or more embodiments, the catalyst may comprise from 19.9 wt. % to 97.9 wt. % of the support material. The support material may comprise one or more inorganic oxides. The one or more inorganic oxides may act as a granulating agent or a binder. Exemplary inorganic oxides include, but are not limited to, alumina, silica, titania, silica-alumina, alumina-titania, alumina-zirconia, alumina-boria, phosphorus-alumina, silica-alumina-boria, phosphorus-alumina-boria, phosphorus-alumina-silica, silica-alumina-titania, and silica-alumina-zirconia. In some embodiments, the support material may comprise alumina, silica-alumina, or both. In various embodiments, the catalyst may comprise at least 19.9 wt. % of the support material and less than or equal to 95 wt. %, less than or equal to 90 wt. %, less than or equal to 80 wt. %, less than or equal to 70 wt. %, less than or equal to 60 wt. %, less than or equal to 50 wt. %, less than or equal to 40 wt. %, or even 30 wt. % of the support material. In some other embodiments, the catalyst may comprise less than or equal to 97.9 wt. % of the support material and at least 30 wt. %, at least 40 wt. %, at least 50 wt. %, at least 60 wt. %, at least 70 wt. %, at least 80 wt. %, or even at least 90 wt. %. It should be understood that the amount of the support material of the catalyst may be in a range formed from any one of the lower bounds for such amounts of the support material described herein to any one of the upper bounds for such amounts of the support material described herein.

In one or more embodiments, the catalyst may comprise from 2 wt. % to 80 wt. % of the zeolitic material comprising the microporous framework. As used throughout this disclosure, “zeolitic material” may refer to one or more zeolites. As used throughout this disclosure, “zeolites” may refer to micropore-containing inorganic materials with regular intra-crystalline cavities and channels of molecular dimension. Zeolites generally comprise a crystalline structure, as opposed to an amorphous structure such as what may be observed in some porous materials such as amorphous silica. Zeolites generally include a microporous framework that may be identified by a framework type. The microporous structure of zeolites (e.g., 0.3 nm to 2 nm pore size) may render large surface areas and desirable size-/shape-selectivity, which may be advantageous for catalysis. The zeolites described may include, for example, aluminosilicates, titanosilicates, or pure silicates. In various embodiments. The catalyst may comprise at least 2 wt. % of the zeolitic material and less than or equal to 80 wt. %, less than or equal to 75 wt. %, less than or equal to 70 wt. %, less than or equal to 65 wt. %, less than or equal to 60 wt. %, less than or equal to 55 wt. %, less than or equal to 50 wt. %, less than or equal to 45 wt. %, less than or equal to 40 wt. %, less than or equal to 35 wt. %, less than or equal to 30 wt. %, less than or equal to 25 wt. %, or even less than or equal to 20 wt. %. In some other embodiments, the catalyst may comprise less than or equal to 80 wt. % of the zeolitic material and at least 5 wt. %, at least 10 wt. %, at least 15 wt. %, at least 20 wt. %, at least 25 wt. %, at least 30 wt. %, at least 35 wt. %, at least 40 wt. %, at least 45 wt. %, at least 50 wt. %, at least 55 wt. %, at least 60 wt. %, at least 65 wt. %, or even at least 70 wt. %. It should be understood that the amount of the zeolitic material of the catalyst may be in a range formed from any one of the lower bounds for such amounts of the zeolitic material described herein to any one of the upper bounds for such amounts of the zeolitic material described herein.

In one or more embodiments, the zeolitic material described may include micropores (present in the microstructure of one or more zeolites), and additionally include mesopores. As used throughout this disclosure, micropores refer to pores in a structure that have a diameter of less than or equal to 2 nm and greater than or equal to 0.1 nm, and mesopores refer to pores in a structure that have a diameter of greater than 2 nm and less than or equal to 50 nm. Unless otherwise described herein, the “pore size” of a material refers to the average pore size, but materials may additionally include mesopores having a particular size that is not identical to the average pore size and thus contain a distribution of pores. The average pore size may be determined from a nitrogen physisorption analysis. Further, the average pore size may be confirmed by transmission electron microscope (TEM) characterization.

Generally, zeolites may be characterized by a framework type, which defines their microporous structure. The zeolites described presently, in one or more embodiments, are not particularly limited by framework type. Framework types are described in, for example, “Atlas of Zeolite Framework Types” by Ch. Baerlocher et al., Fifth Revised Edition, 2001, which is incorporated by reference herein.

According to one or more embodiments, the zeolitic material, that includes one or more zeolites described herein, may include at least silicon atoms and oxygen atoms. In some embodiments, the microporous framework may include substantially only silicon and oxygen atoms (e.g., silica material). However, in additional embodiments, the one or more zeolites may include other atoms, such as aluminum. Such zeolites may be aluminosilicate zeolites. In one or more embodiments, the microporous framework may consist of silica and alumina. In additional embodiments, the microporous framework may include titanium atoms, and such zeolites may be titanosilicate zeolites. In additional embodiments, the microporous framework may include zirconium atoms, and such zeolites may be zirconosilicate zeolites.

In one or more embodiments, the zeolitic material may comprise an aluminosilicate microstructure. The zeolitic material may comprise at least 99 wt. % of the combination of silicon atoms, oxygen atoms, and aluminum atoms. The molar ratio of Si/Al may be from 0.75 to 500. For example, without limitation, the molar ratio of Si/Al may be from 0.75 to 500, from 0.75 to 450, from 0.75 to 400, from 0.75 to 300, from 0.75 to 200, from 0.75 to 100, from 0.75 to 75, from 0.75 to 50, from 0.75 to 40, from 0.75 to 30, from 0.75 to 20, from 0.75 to 10, from 1.0 to 500, from 1.0 to 450, from 1.0 to 400, from 1.0 to 300, from 1.0 to 200, from 1.0 to 100, from 1.0 to 75, from 1.0 to 50, from 1.0 to 40, from 1.0 to 30, from 1.0 to 20, from 1.0 to 10, from 1.5 to 500, from 1.5 to 450, from 1.5 to 400, from 1.5 to 300, from 1.5 to 200, from 1.5 to 100, from 1.5 to 75, from 1.5 to 50, from 1.5 to 40, from 1.5 to 30, from 1.5 to 20, from 1.5 to 10, from 2.5 to 500, from 2.5 to 450, from 2.5 to 400, from 2.5 to 300, from 2.5 to 200, from 2.5 to 100, from 2.5 to 75, from 2.5 to 50, from 2.5 to 40, from 2.5 to 30, from 2.5 to 20, from 2.5 to 10, from 5 to 500, from 5 to 450, from 5 to 400, from 5 to 300, from 5 to 200, from 5 to 100, from 5 to 75, from 5 to 50, from 5 to 40, from 5 to 30, from 5 to 20, from 5 to 10 or a range where any two listed numbers comprise the endpoints of that range.

In one or more embodiments, the one or more zeolites of the zeolitic material may comprise microstructures (which include micropores) characterized by, among others as *BEA framework type zeolites (such as, but not limited to, zeolite Beta), FAU framework type zeolites (such as, but not limited to, zeolite Y or ultra-stable zeolite Y), MOR framework type zeolites, MFI framework type zeolite (such as, but not limited to, ZSM-5 or Silicalite-1), CHA framework type zeolite (such as, but not limited to chabazite zeolite), LTL framework type zeolite (such as but not limited to zeolite L), LTA framework zeolite (such as but not limited to zeolite A), AEI framework type zeolite, or MWW framework type zeolite (such as but not limited to MCM-22). It should be understood that *BEA, MFI, MOR, FAU, CHA, LTL, LTA, AEI, and MWW refer to zeolite framework types as identified by their respective three letter codes established by the International Zeolite Association (IZA). Other framework types are contemplated in the presently disclosed embodiments.

In one or more embodiments, the zeolitic material may comprise an FAU framework type zeolite, such as zeolite Y or ultra-stable zeolite Y (USY). As used herein, “zeolite Y” and “USY” refer to a zeolite having a FAU framework type according to the IZA zeolite nomenclature and consisting majorly of silica and alumina, as would be understood by one skilled in the art. In one or more embodiments, USY may be prepared from zeolite Y by steaming zeolite Y at temperatures above 500° C. The molar ratio of silica to alumina may be at least 3. For example, the molar ratio of silica to alumina in the zeolite Y may be at least 5, at least 12, at least 30, or even at least 200, such as from 5 to 200, from 12 to 200, from about 15 to about 200, or from about 20 to 100.

In one or more embodiments, the microporous framework of the zeolitic material may comprise zirconium oxide, titanium oxide, or both. Such zeolites including zirconium oxide and/or titanium oxide in the microporous framework of the zeolitic material may also be referred to as a framework-substituted zeolite.

In one or more embodiments, the zeolitic material may comprise from 0.1 wt. % to 5 wt. % of zirconium oxide. Without intending to be bound by any particular theory, it is believed that the zeolitic material having less than 0.1 wt. % of zirconium oxide may result in a zeolite having insufficient acidity, resulting in a decrease in the catalytic activity of the catalyst comprising the zeolitic material. Further, it is believed that the zeolitic material having greater than 5 wt. % of zirconium oxide may result in a catalyst having an ineffective pore volume for the hydrocracking of the hydrocarbon oil. In one or more embodiments, the zeolitic material may comprise from 0.1 wt. % to 4 wt. %, from 0.1 wt. % to 3 wt. %, from 0.1 wt. % to 2 wt. %, from 0.1 wt. % to 1 wt. %, from 0.1 wt. % to 0.5 wt. %, from 0.1 wt. % to 0.4 wt. %, from 0.1 wt. % to 0.3 wt. %, or from 0.1 wt. % to 0.2 wt. % zirconium oxide.

In one or more embodiments, the zeolitic material may comprise from 0.1 wt. % to 5 wt. % of titanium oxide. Without intending to be bound by any particular theory, it is believed that the zeolitic material having less than 0.1 wt. % of titanium oxide may result in a zeolitic material having insufficient acidity, resulting in a decrease in the catalytic activity of the catalyst comprising the zeolitic material. Further, it is believed that the zeolitic material having greater than 5 wt. % of titanium oxide may result in a catalyst having an ineffective pore volume for the hydrocracking of the hydrocarbon oil. In one or more embodiments, the zeolitic material may comprise from 0.1 wt. % to 4 wt. %, from 0.1 wt. % to 3 wt. %, from 0.1 wt. % to 2 wt. %, from 0.1 wt. % to 1 wt. %, from 0.1 wt. % to 0.5 wt. %, from 0.1 wt. % to 0.4 wt. %, from 0.1 wt. % to 0.3 wt. %, or from 0.1 wt. % to 0.2 wt. % titanium oxide.

The amount of zirconium oxide and/or titanium oxide in the zeolitic material can be measured by, for example, an X-ray fluorescence analyzer, a high frequency plasma emission spectrometer, an atomic absorption spectrometer, or the like.

In one or more embodiments, the zeolitic material may have a specific surface area from 600 m²/g to 900 m²/g. Without intending to be bound by any particular theory, it is believed that a specific surface area of the zeolitic material of less than 600 m²/g may result in a reduction in the number of available solid acid sites, thereby reducing the catalyst activity of the catalyst to an unsatisfactory level. Further, it is believed that a zeolitic material having a surface area of greater than 900 m²/g may be difficult to produce. For example, the specific surface area of the zeolitic material may be from 610 m²/g to 890 m²/g, from 620 m²/g to 880 m²/g, from 630 m²/g to 870 m²/g, from 640 m²/g to 860 m²/g, from 650 m²/g to 850 m²/g, from 660 m²/g to 840 m²/g, from 670 m²/g to 830 m²/g, from 680 m²/g to 820 m²/g, from 690 m²/g to 810 m²/g, from 700 m²/g to 800 m²/g, from 710 m²/g to 790 m²/g, from 720 m²/g to 780 m²/g, from 730 m²/g to 770 m²/g, or even from 740 m²/g to 760 m²/g. It should be understood that the specific surface area of the zeolitic material may be in a range formed from any one of the lower bounds for such specific surface area described herein to any one of the upper bounds for such specific surface area described herein.

In one or more embodiments, the zeolitic material may have a pore volume of from 0.5 mL/g to 1.0 mL/g. The term “pore volume” may refer to the total volume of the pores of the zeolitic material per gram of the zeolitic material. In some embodiments, the zeolitic material may have a pore volume of less than or equal to 1.0 mL/g and at least 0.5 mL/g, at least 0.55 mL/g, or at least 0.6 mL/g, at least 0.65 mL/g, at least 0.7 mL/g, at least 0.75 mL/g, at least 0.8 mL/g, at least 0.85 mL/g, at least 0.9 mL/g, or even at least 0.95 mL/g. In some embodiments, the zeolitic material may have a pore volume of greater than or equal to 0.5 mL/g and less than or equal to 0.55 mL/g, less than or equal to 0.6 mL/g less than or equal to 0.65 mL/g, less than or equal to 0.7 mL/g, less than or equal to 0.75 mL/g less than or equal to 0.8 mL/g, less than or equal to 0.85 mL/g, less than or equal to 0.9 mL/g, less than or equal to 0.95 mL/g, or even less than or equal to 1.0 mL/g. It should be understood that the pore volume of the zeolitic material may be in a range formed from any one of the lower bounds for such amounts of the pore volume of the zeolitic material described herein to any one of the upper bounds for such pore volumes of the zeolitic material described herein. The pore volume is determined from pore distribution obtained by calculating and analyzing a desorption data of nitrogen by a Barrett-Joyner-Halenda (BJH) method.

In one or more embodiments, the zeolitic material may have a crystal lattice constant from 2.43 nm to 2.45 nm. Without intending to be bound by any particular theory, it is believed that a crystal lattice constant for the zeolitic material of less than 2.43 nm may result in a reduction in the activity of the catalyst suitable for hydrocracking. Such reduction is believed to be the result of a high SiO₂/Al₂O₃ molar ratio in the microporous framework of the zeolitic material and a small number of solid acid sites serving as active sites for the decomposition of hydrocarbons. Conversely, a crystal lattice constant for the zeolitic material exceeding 2.45 nm may result in breakage of a crystal structure of the zeolitic material during a hydrocracking reaction because of a low heat resistance of the zeolitic material. The breakage of the crystal structure of the zeolitic material may result in a reduction in the activity of the catalyst suitable for hydrocracking For example, the crystal lattice constant of the zeolitic material may be from 2.431 nm to 2.449 nm, from 2.432 nm to 2.448 nm, from 2.433 nm to 2.447 nm, from 2.434 nm to 2.446 nm, from 2.435 nm to 2.445 nm, from 2.436 nm to 2.444 nm, from 2.437 nm to 2.443 nm, from 2.438 nm to 2.442 nm, or even from 2.439 nm to 2.441 nm. It should be understood that the crystal lattice constant of the zeolitic material may be in a range formed from any one of the lower bounds for such crystal lattice constant described herein to any one of the upper bounds for such crystal lattice constant described herein. The zeolitic material may have a crystal lattice constant of a=from 1.26 nm to 1.27 nm, b=from 1.26 nm to 1.27 nm, and c=from 26.2 nm to 26.5 nm or a=from 1.263 nm to 1.267 nm, b=from 1.263 nm to 1.263 nm, and c=from 26.3 nm to 26.4 nm. It should be understood that the crystal lattice constant of the zeolitic material may be in a range formed from any one of the lower bounds for such crystal lattice constant described herein to any one of the upper bounds for such crystal lattice constant described herein. Without intending to be bound by any particular theory, it is believed that similar effects may be observed above the maximum crystal lattice constants described above for zeolitic material and below the minimum crystal lattice constants described above for the zeolitic material. The crystal lattice constant can be measured by reference to an ASTM method, D-3942: Standard Test Method for Determination of the Unit Cell Dimension of a Faujasite-Type.

In one or more embodiments, the catalyst may comprise from 0.1 wt. % to 40 wt. % of the one or more metals, one or more metal oxides, or both, wherein the one or more metals are chosen from cobalt atoms, molybdenum atoms, nickel atoms, tungsten atoms, or combinations thereof, wherein the one or more metal oxides are chosen from cobalt oxide, molybdenum oxide, nickel oxide, tungsten oxide, or combinations thereof. As used herein, the “one or more metals, one or more metal oxides, or both” may refer to a material distinct from the support material and/or the zeolitic material. The one or more metals, one or more metal oxides, or both may be disposed on the microporous framework of the zeolitic material, the support material, or both. Without intending to be bound by any particular theory, it is believed that the inclusion of the one or more metals, one or more metal oxides, or both, wherein the one or more metals are chosen from cobalt atoms, molybdenum atoms, nickel atoms, tungsten atoms, or combinations thereof, wherein the one or more metal oxides are chosen from cobalt oxide, molybdenum oxide, nickel oxide, tungsten oxide, or combinations thereof in the catalyst may increase the hydrogenative activity of the catalyst. In one or more embodiments, the catalyst may comprise the one or more metals, one or more metal oxides, or both, wherein the one or more metals are chosen from cobalt atoms, molybdenum atoms, nickel atoms, tungsten atoms, or combinations thereof, wherein the one or more metal oxides are chosen from cobalt oxide, molybdenum oxide, nickel oxide, tungsten oxide, or combinations thereof in an amount from 0.1 wt. % to 40 wt. %, from 0.1 wt. % to 35 wt. %, from 1 wt. % to 30 wt. %, from 1.5 wt. % to 25 wt. %, from 2 wt. % to 20 wt. %, from 2 wt. % to 15 wt. %, 5 wt. % to 35 wt. %, from 5 wt. % to 30 wt. %, from 5 wt. % to 25 wt. %, from 5 wt. % to 20 wt. %, from 5 wt. % to 15 wt. %, from 10 wt. % to 40 wt. %, from 10 wt. % to 35 wt. %, from 10 wt. % to 30 wt. %, from 10 wt. % to 25 wt. %, from 10 wt. % to 20 wt. %, from 10 wt. % to 15 wt. %, from 15 wt. % to 40 wt. %, from 15 wt. % to 35 wt. %, from 15 wt. % to 30 wt. %, from 15 wt. % to 25 wt. %, from 15 wt. % to 20 wt. %, or a range where any two listed numbers comprise the endpoints of that range. For example, without limitation, in some embodiments, the catalyst may comprise from 10 wt. % to 20 wt. % molybdenum oxide and from 2 wt. % to 5 wt. % nickel oxide.

In one or more embodiments, the catalyst may have a surface area of from 200 m²/g to 450 m²/g. The term “surface area” may refer to the total area of the surface of the catalyst per gram of the catalyst. In some embodiments, the catalyst may have a surface area of less than or equal to 450 m²/g and at least 200 m²/g, at least 225 m²/g, at least 250 m²/g, at least 275 m²/g, at least 300 m²/g, at least 325 m²/g, at least 350 m²/g, at least 375 m²/g, at least 400 m²/g, or even at least 425 m²/g. In one or more embodiments, the catalyst may have a surface area of at least 200 m²/g and less than or equal to 225 m²/g, less than or equal to 250 m²/g, less than or equal to 275 m²/g, less than or equal to 300 m²/g, less than or equal to 325 m²/g, less than or equal to 350 m²/g, less than or equal to 375 m²/g, less than or equal to 400 m²/g, less than or equal to 425 m²/g, or even less than or equal to 450 m²/g. It should be understood that the surface area of the catalyst may be in a range formed from any one of the lower bounds for such amounts of surface area of the catalyst described herein to any one of the upper bounds for such amounts of the surface area of the catalyst described herein.

In one or more embodiments, the catalyst may have a pore volume of from 0.5 mL/g to 1.0 mL/g. The term “pore volume” may refer to the total volume of the pores of the catalyst per gram of the catalyst. In some embodiments, the catalyst may have a pore volume of less than or equal to 1.0 mL/g, and at least 0.5 mL/g, at least 0.55 mL/g, or at least 0.6 mL/g, at least 0.65 mL/g, at least 0.7 mL/g, at least 0.75 mL/g, at least 0.8 mL/g, at least 0.85 mL/g, at least 0.9 mL/g, or even at least 0.95 mL/g. In some embodiments, the catalyst may have a pore volume of greater than or equal to 0.5 mL/g and less than or equal to 0.55 mL/g, less than or equal to 0.6 mL/g less than or equal to 0.65 mL/g, less than or equal to 0.7 mL/g, less than or equal to 0.75 mL/g less than or equal to 0.8 mL/g, less than or equal to 0.85 mL/g, less than or equal to 0.9 mL/g, less than or equal to 0.95 mL/g, or even less than or equal to 1.0 mL/g. It should be understood that the pore volume of the catalyst may be in a range formed from any one of the lower bounds for such amounts of the pore volume of the catalyst described herein to any one of the upper bounds for such pore volumes of the catalyst described herein. The pore volume is determined from pore distribution obtained by calculating and analyzing desorption data of nitrogen by a BJH method. In one or more embodiments, the catalyst may include a plurality of pores having a diameter of 600 Å or less. These pores having a diameter of 600 Å may have a volume from 0.4 ml/g to 0.75 ml/g. Without intending to be bound by any particular theory, it is believed that the specific surface area is reduced if the pore volume is less than 0.40 ml/g. As a result, the catalyst activity and yield of the middle distillates are reduced. Conversely, if the pore volume exceeds 0.75 ml/g, the specific surface area is elevated. As a result, the hydrocracking rate and the product selectivity may be changed unfavorably. In one or more embodiments, the pore volume of the plurality of pores having a diameter of 600 Å may be in the range from 0.41 ml/g to 0.74 ml/g, from 0.42 ml/g to 0.73 ml/g, from 0.43 ml/g to 0.72 ml/g, from 0.44 ml/g to 0.71 ml/g, from 0.45 ml/g to 0.7 ml/g, from 0.46 ml/g to 0.69 ml/g, from 0.47 ml/g to 0.68 ml/g, from 0.48 ml/g to 0.67 ml/g, from 0.49 ml/g to 0.66 ml/g, from 0.5 ml/g to 0.65 ml/g, from 0.51 ml/g to 0.64 ml/g, from 0.52 ml/g to 0.63 ml/g, from 0.53 ml/g to 0.62 ml/g, from 0.54 ml/g to 0.61 ml/g, from 0.55 ml/g to 0.6 ml/g, from 0.56 ml/g to 0.59 ml/g, or even from 0.57 ml/g to 0.58 ml/g. It should be understood that the pore volume of pores of the catalyst having a diameter of 600 Å or less may be in a range formed from any one of the lower bounds for such pore volume described herein to any one of the upper bounds for such pore volume described herein.

Methods of making the catalysts suitable for hydrocracking described herein are also disclosed herein. Methods of making the catalysts suitable for hydrocracking may include contacting an initial catalyst with a passivation agent to form a passivated catalyst, contacting the passivated catalyst with a metal precursor to form a doped catalyst, and heating the doped catalyst to form the catalyst suitable for hydrocracking.

In one or more embodiments, the initial catalyst may comprise the zeolitic material and the support material described herein. The initial catalyst may comprise acid sites. In one or more embodiments, during the contacting of the initial catalyst with the passivation agent, the passivation agent may bind to a portion or all of the acid sites on the initial catalyst. In one or more embodiments, the passivation agent may comprise a material having the formula R—NH₂, wherein R is a hydrocarbyl, a heterohydrocarbyl, or hydrogen (H). In one or more embodiments, the passivation agent may comprise a material having the formula R—NH₂, wherein R is a hydrocarbyl, a heterohydrocarbyl, hydrogen (H), an alkyl, or an aromatic moiety. In one or more embodiments, the passivation agent may comprise a material having an amino moiety. In one or more embodiments, the passivation agent may comprise a material comprising a primary amine, a secondary amine, a tertiary amine, a cyclic amine, or combinations thereof. As used herein, the term “hydrocarbyl” refers to a hydrocarbon radical. As used herein, the term “heterohydrocarbyl” refers to a heterohydrocarbon radical. In one or more embodiments, the passivation agent comprises, consists essentially of, or consists of ammonia. In one or more embodiments, contacting the initial catalyst with the passivation agent may comprise contacting the initial catalyst with a passivation solution that comprises the passivation agent, wherein the passivation solution comprises the passivation agent at a concentration of from greater than or equal to 1 wt. % and less than or equal to 30 wt. %, less than or equal to 25 wt. %, less than or equal to 20 wt. %, less than or equal to 15 wt. %, or less than or equal to 10 wt. %, from greater than or equal to 5 wt. % and less than or equal to 30 wt. %, less than or equal to 25 wt. %, less than or equal to 20 wt. %, less than or equal to 15 wt. %, or less than or equal to 10 wt. %, from greater than or equal to 10 wt. % and less than or equal to 30 wt. %, less than or equal to 25 wt. %, less than or equal to 20 wt. %, or less than or equal to 15 wt. %, from greater than or equal to 15 wt. % and less than or equal to 30 wt. %, less than or equal to 25 wt. %, or less than or equal to 20 wt. %.

After contacting the initial catalyst with the passivation agent to form the passivated catalyst, the method may include contacting the passivated catalyst with the metal precursor to form the doped catalyst. In one or more embodiments, the metal precursor may comprise one or more metals, one or more metal salts, or combinations thereof, comprising cobalt atoms, molybdenum atoms, nickel atoms, tungsten atoms, or combinations thereof. For example, in one embodiment, the passivated catalyst, which includes the support material and the zeolitic material, may be impregnated with one or more metals, one or more metal salts, or combinations thereof, comprising cobalt atoms, molybdenum atoms, nickel atoms, tungsten atoms, or combinations thereof. According to embodiments, the impregnation of the passivated catalyst may comprise contacting the passivated catalyst with a solution comprising the metal precursor. For example, the passivated catalyst may be submerged in the metal solution comprising the metal precursor, an impregnation method sometimes referred to as a saturated impregnation. In one or more embodiments of saturated impregnation, the passivated catalyst may be submerged in an amount of the solution comprising the metal precursor 2 to 4 times of that which is absorbed by the support material, and the remaining solution may subsequently be removed. According to another embodiment, the impregnation may be by incipient wetness impregnation, sometimes referred to as capillary impregnation or dry impregnation. In one or more embodiments of incipient wetness impregnation, the passivated catalyst may be contacted with the solution comprising the one or more metal precursor, where the amount of the solution is approximately equal to the pore volume of the passivated catalyst and capillary action may draw the solution into the pores.

After the contacting of the passivated catalyst with the metal precursor to form the doped catalyst, the doped catalyst may be heated to form the catalyst suitable for hydrocracking. For example, without limitation, the heating may comprise heating the doped catalyst at a temperature of at least 500° C. such that the doped catalyst is calcined. For example, and without limitation, the doped catalyst may be heated at a temperature, such as from 500° C. to 600° C. for a time of at least 10 minutes, such as about 10 minutes to 6 hours. For example, the doped catalyst may be heated at a temperature of 550° C. for 1 hour. Generally, the impregnation process may allow for attachment of the metal of the metal precursor onto the passivated catalyst (that is, the zeolitic material and the support material). The metal precursor may include cobalt atoms, molybdenum atoms, nickel atoms, tungsten atoms, or combinations thereof, and following the impregnation, may be present on the catalyst as compounds comprising Ni, W, Mo, Co, or combinations thereof. Two or more metals of the metal precursor may be utilized when two or more metal dopants on the catalyst are desired. However, some embodiments may include only one of Ni, W, Mo, or Co. For example, the catalyst support material may be impregnated by a mixture of nickel nitrate hexahydrate (that is, Ni(NO₃)₂·6H₂O) and ammonium metatungstate (that is, (NH₄)₆H₂W₁₂O₄₀) if a W—Ni catalyst is desired. While it should be understood that the scope of the present disclosure should not be limited by the metal precursor selected, other suitable metal precursors may include cobalt nitrate hexahydrate (Co(NO₃)₂·6H₂O), ammonia heptamolybdate ((NH₄)₆Mo₇O₂₄·4H₂O), or ammonium molybdate ((NH₄)₂MoO₄). Following impregnation, the impregnated metal catalysts may be present as a metal oxide, such as WO₃, MoO₃, NiO, and CoO, and may also be referred to in this disclosure as “metal catalyst materials.” While these metal catalyst materials may include metal oxides, it should be appreciated that the metal catalyst materials are distinct from the support material of the catalyst which may, in some embodiments, be alumina.

Without intending to be bound by any particular theory, it is believed that passivating the initial catalyst may block at least a portion of hydroxyl groups associated with acid sites on the passivated catalyst, which may lead to a decrease in a dispersion of the metal catalyst materials on the catalyst. In general, it is believed that metals from the metal precursor may deposit on the hydroxyl groups of the support material, the zeolitic material, or both, making a covalent bond with the support material, the zeolitic material, or both, after calcination. Without intending to be bound by any particular theory, it is believed that if hydroxyl groups are blocked by the passivation agent, the metals from the metal precursor may agglomerate on the catalyst, decreasing the dispersion of the metal catalyst materials on the catalyst. Further, it is believed that this decrease in the dispersion of the metal catalyst materials on the catalyst may reduce a hydrogenation ability of the catalyst, thereby increasing naphtha yield during the hydrocracking of the hydrocarbon oil.

In one or more embodiments, the method of making the catalyst may comprise making the initial catalyst. In one or more embodiments, making the initial catalyst may comprise forming a catalyst precursor mixture comprising the support material and the zeolitic material, as described herein. In one or more embodiments, the method may comprise substituting alumina in a framework of the zeolitic material with zirconium, titanium, or both, prior to forming the catalyst precursor mixture. In one or more embodiments, the method may comprise extruding the catalyst precursor mixture to form an extrudate, and calcining the extrudate to form the initial catalyst prior to contacting the initial catalyst with the passivation agent. Methods for making the initial catalyst and the zeolitic material are described in U.S. Pat. Nos. 9,221,036, 10,293,332, and 10,293,332, the entirety of each which are incorporated by reference herein.

The catalyst described herein may be used in methods of hydrocracking hydrocarbons in a hydrocarbon oil. Such methods may comprise contacting the hydrocarbon oil with the catalyst in the presence of hydrogen in a reactor. In one or more embodiments, the hydrocarbon oil may have a boiling point from 200° C. to 833° C. For example, and without limitation, the hydrocarbon oil may have a boiling point from 200° C. to 800° C., from 225° C. to 800° C., from 250° C. to 800° C., from 275° C. to 800° C., from 300° C. to 800° C., from 350° C. to 800° C., from 350° C. to 750° C., from 350° C. to 700° C., from 350° C. to 675° C., from 350° C. to 650° C., from 375° C. to 800° C., from 375° C. to 750° C., from 375° C. to 700° C., from 375° C. to 675° C., from 375° C. to 650° C., or a range where any two listed numbers comprise the endpoints of that range.

In one or more embodiments, the hydrocarbon oil can have an initial boiling point temperature of less than or equal to 450° C., and greater than or equal to 200° C., greater than or equal to 225° C., greater than or equal to 250° C., greater than or equal to 300° C., greater than or equal to 325° C., greater than or equal to 350° C., or even greater than or equal to 375° C., as determined according to standard test method ASTM D7169. In one or more embodiments, the hydrocarbon oil can have an initial boiling point temperature of greater than or equal to 200° C., and less than or equal to 400° C., less than or equal to 375° C., less than or equal to 350° C., less than or equal to 300° C., less than or equal to 250° C., or even less than or equal to 225° C., as determined according to standard test method ASTM D7169. In one or more embodiments, the hydrocarbon oil can have an end boiling point temperature of less than or equal to 800° C., and greater than or equal to 500° C., greater than or equal to 525° C., greater than or equal to 550° C., greater than or equal to 575° C., or greater than or equal to 600° C., as determined according to standard test method ASTM D7169. In one or more embodiments, the hydrocarbon oil can have an end boiling point temperature of greater than or equal to 500° C., and less than or equal to 800° C., less than or equal to 700° C., less than or equal to 650° C., or even less than or equal to 600° C., as determined according to standard test method ASTM D7169. In one or more embodiments, the hydrocarbon oil can have a 5 wt. % boiling point temperature of at least 250° C., and less than or equal to 500° C., less than or equal to 450° C., less than or equal to 400° C., less than or equal to 390° C., less than or equal to 350° C., or even less than or equal to 325° C., as determined according to standard test method ASTM D7169. In one or more embodiments, the hydrocarbon oil can have a 5 wt. % boiling point temperature of at least 300° C., and less than or equal to 500° C., less than or equal to 450° C., less than or equal to 400° C., less than or equal to 390° C., less than or equal to 350° C., or even less than or equal to 325° C., as determined according to standard test method ASTM D7169. In one or more embodiments, the hydrocarbon oil can have a 5 wt. % boiling point temperature of less than or equal to 500° C., and greater than or equal to 300° C., greater than or equal to 305° C., greater than or equal to 315° C., greater than or equal to 325° C., greater than or equal to 350° C., or even greater than or equal to 375° C., as determined according to standard test method ASTM D7169. In one or more embodiments, less than 5 wt. % of the hydrocarbon oil may have a boiling point of less than or equal to 260° C., less than or equal to 275° C., less than or equal to 300° C., less than or equal to 325° C., or less than or equal to 360° C. In one or more embodiments, the hydrocarbon oil can have a 50 wt. % boiling point temperature of greater than or equal to 400° C., and less than or equal to 550° C., less than or equal to 500° C., or less than or equal to 455° C., as determined according to standard test method ASTM D7169. In one or more embodiments, the hydrocarbon oil can have a 50 wt. % boiling point temperature of less than or equal to 550° C. and greater than or equal to 400° C., greater than or equal to 425° C., or greater than or equal to 435° C., as determined according to standard test method ASTM D7169. In one or more embodiments, greater than 50 wt. % of the hydrocarbon oil may have a boiling point of greater than or equal to 400° C., greater than or equal to 425° C., or greater than or equal to 450° C. In one or more embodiments, the hydrocarbon oil can have a 70 wt. % boiling point temperature of at least 425° C., and less than or equal to 550° C., less than or equal to 500° C., or less than or equal to 490° C., as determined according to standard test method ASTM D7169. In one or more embodiments, the hydrocarbon oil can have a 70 wt. % boiling point temperature of less than or equal to 550° C. and greater than or equal to 400° C., greater than or equal to 425° C., greater than or equal to 450° C., or greater than or equal to 470° C., as determined according to standard test method ASTM D7169. In one or more embodiments, the hydrocarbon oil can have a 95 wt. % boiling point temperature of greater than or equal to 500° C., and less than or equal to 800° C., less than or equal to 700° C., less than or equal to 650° C., or even less than or equal to 600° C., as determined according to standard test method ASTM D7169. It should be understood that the boiling point temperatures of the hydrocarbon oil may be in a range formed from any one of the lower bounds for such boiling point temperatures described herein to any one of the upper bounds for such boiling point temperatures described herein.

In one or more embodiments, the hydrocarbon oil may contain refined oil obtained from crude oil, synthetic crude oil, bitumen, oil sand, shell oil, coal liquid, or combinations thereof. In one or more embodiments, the hydrocarbon oil may comprise (a) vacuum gas oil (VGO), (b) deasphalted oil (DAO) obtained from a solvent deasphalting process or demetalled oil, (c) light coker gas oil or heavy coker gas oil obtained from a coker process, (d) cycle oil obtained from a fluid catalytic cracking (FCC) process, (c) gas oil obtained from a visbraking process, or combinations thereof.

In one or more embodiments, the reactor may have a hydrogen pressure from 40 kg/cm² to 300 kg/cm² during the contacting. For example, without limitation, the reactor may have a hydrogen partial pressure from 40 kg/cm² to 300 kg/cm², from 40 kg/cm² to 250 kg/cm², from 40 kg/cm² to 200 kg/cm², from 40 kg/cm² to 150 kg/cm², from 80 kg/cm² to 300 kg/cm², from 80 kg/cm² to 250 kg/cm², from 80 kg/cm² to 200 kg/cm², from 80 kg/cm² to 150 kg/cm², or a range where any two listed numbers comprise the endpoints of that range.

In one or more embodiments, the reactor may have a volumetric ratio of the hydrogen to the hydrocarbon oil during the contacting from 500 Nm³/m³ to 2,500 Nm³/m³. For example, without limitation, the reactor may have a volumetric ratio of the hydrogen to the hydrocarbon oil during the contacting from 500 Nm³/m³ to 2,500 Nm³/m³, from 500 Nm³/m³ to 2,000 Nm³/m³, from 500 Nm³/m³ to 1,500 Nm³/m³, from 500 Nm³/m³ to 1,250 Nm³/m³, from 750 Nm³/m³ to 2,500 Nm³/m³, from 750 Nm³/m³ to 2,000 Nm³/m³, from 750 Nm³/m³ to 1,500 Nm³/m³, from 750 Nm³/m³ to 1,250 Nm³/m³, or a range where any two listed numbers comprise the endpoints of that range.

In one or more embodiments, a ratio of the hydrogen to the hydrocarbon oil during the contacting may be from 100 standard liters of hydrogen per liter of vacuum gas oil (StL/L) to 5,000 StL/L. For example, without limitation, the ratio of the hydrogen to the hydrocarbon oil during the contacting may be from 100 St/L to 5,000 StL/L, from 200 St/L to 4,000 StL/L, from 300 St/L to 3,000 StL/L, from 400 St/L to 2,000 StL/L, from 500 St/L to 1,500 StL/L, from 750 St/L to 1,250 StL/L, or a range where any two listed numbers comprise the endpoints of that range.

In one or more embodiments, the hydrocarbon oil and the catalyst may be contacted at a liquid hourly space velocity (LHSV) of from 0.1 h⁻¹ to 10 h⁻¹. For example, without limitation, the method may include a LHSV of from 0.1 h⁻¹ to 10 h⁻¹, from 0.1 h⁻¹ to 8 h⁻¹, from 0.1 h⁻¹ to 6 h⁻¹, from 0.1 h⁻¹ to 4 h⁻¹, from 0.1 h⁻¹ to 2 h⁻¹, from 0.1 h⁻¹ to 1 h⁻¹, from 0.3 h⁻¹ to 2 h⁻¹, or a range where any two listed numbers comprise the endpoints of that range.

In one or more embodiments, the reactor may be heated to a temperature of from 300° C. to 500° C. during the contacting. For example, without limitation, the reactor may be heated to a temperature of from 300° C. to 500° C., from 325° C. to 500° C., from 350° C. to 500° C., from 300° C. to 450° C., from 325° C. to 450° C., from 350° C. to 450° C., from 300° C. to 400° C., from 325° C. to 400° C., from 350° C. to 400° C., or a range where any two listed numbers comprise the endpoints of that range during the contacting.

In one or more embodiments, the reactor may be a flow reactor. For example, without limitation, the reactor may be a flow reactor comprising a stirred tank, an ebullient bed reactor, a baffled slurry tank, a fixed bed reactor, a rotating tubular reactor, or a slurry-bed reactor.

In one or more embodiments, the contacting may cause a least a portion of the hydrocarbons in the hydrocarbon oil to produce a cracked effluent. In one or more embodiments, the cracked effluent produced from the method may comprise hydrocarbons comprising gas, naphtha, kerosene, gasoil, and unconverted bottoms. As used herein, the term “gas” refers to C1-C4 hydrocarbons. As used herein, the term “naphtha” refers to hydrocarbons having a boiling point of from about at least 32° C. and less than or equal to 145° C. As used herein, the term “kerosene” refers to hydrocarbons having a boiling point of greater than 145° C. and less than or equal to 260° C. As used herein, the term “gasoil” refers to hydrocarbons having a boiling point of greater than 260° C. and less than or equal to 360° C. As used herein, the term “unconverted bottoms” refers to hydrocarbons having a boiling point of greater than 360° C.

The catalyst used in the methods described herein may increase the conversion of the hydrocarbon oil to naphtha compared to conventional catalysts that wherein when the conventional catalyst is utilized in a hydrocracking reaction to crack vacuum gas oil, the activation energy of the hydrocracking reaction is greater than 55 Kcal/mol, wherein the vacuum gas oil has an initial boiling point of from 205° C. to 225° C. and a 95 wt. % boiling point of from 555° C. to 575° C., and the ratio of hydrogen to vacuum gas oil is 1,000 StL/L. In one or more embodiments, the cracked effluent may comprise less than 20 wt. % naphtha and at least 6 wt. %, at least 7 wt. %, or at least 8 wt. %. In one or more embodiments, the cracked effluent may comprise at least 6 wt. % naphtha, and less than 20 wt. %, less than 15 wt. %, or less than 10 wt. % naphtha. It should be understood that the amount of naphtha in the cracked effluent may be in a range formed from any one of the lower bounds for such amounts of the amount of naphtha in the cracked effluent described herein to any one of the upper bounds for such amounts of the amount of naphtha in the cracked effluent described herein.

The catalyst used in the methods described herein may reduce the reactor temperature needed to achieve 50 wt. % conversion of the hydrocarbon oil compared to conventional catalysts that wherein when the conventional catalyst is utilized in a hydrocracking reaction to crack vacuum gas oil, the activation energy of the hydrocracking reaction is greater than 55 Kcal/mol, wherein the vacuum gas oil has an initial boiling point of from 205° C. to 225° C. and a 95 wt. % boiling point of from 555° C. to 575° C., and the ratio of hydrogen to vacuum gas oil is 1,000 StL/L. Without intending to be bound by any particular theory, it is believed that the reduction of the activation energy of the catalyst, at least in part, may reduce the reactor temperature needed to achieve 50 wt. % conversion of the hydrocarbon oil.

### EXAMPLES

Examples are provided herein which may disclose one or more embodiments of the present disclosure. However, the Examples should not be viewed as limiting on the claimed embodiments hereinafter provided.

### Example 1-1—Preparation of Framework Substituted Zeolite Y

First, 50 kg of a NaY zeolite (hereinafter, also referred to as “NaY”) having a SiO₂/Al₂O₃ molar ratio of 5.2, a unit cell dimension (UD) of 2.466 nm, a surface area (SA) of 720 m²/g, and a Na₂O content of 13.0% by mass was suspended in water having a temperature of 60° C. at a ratio of 10 liters of water per kilogram (L/kg). Ammonium sulfate was added thereto at a ratio of 36 L/kg. The resulting suspension was stirred at 70° C. for 1 hour and filtered. The resulting solid was washed with water, dried at 130° C. for 20 hours, thereby producing zeolite Y (NH₄ ⁶⁵Y) in which 65% of sodium (Na) contained in NaY was ion-exchanged with ammonium ion (NH₄⁺). A content of Na₂O in NH₄ ⁶⁵Y was 4.5% by mass.

The NH₄ ⁶⁵Y was fired in a saturated water vapor atmosphere at 670° C. for 1 hour to form a hydrogen-Y zeolite (HY). HY was suspended in water having a temperature of 60° C. Then ammonium sulfate was added thereto at a ratio of 10.3 L/kg. The resulting mixture was stirred at 90° C. for 1 hour and washed with water having a temperature of 60° C. The mixture was then dried at 130° C. for 20 hours, thereby producing zeolite Y (NH₄ ⁹⁵Y) in which 95% of Na contained in the initial NaY was ion-exchanged with NH₄. The NH₄ ⁹⁵Y obtained was 82 wt. % of the NH₄ ⁶⁵Y prepared. The NH₄ ⁹⁵Y was fired in a saturated water vapor atmosphere at 650° C. for 1 hour, thereby producing an ultra stable Y zeolite (hereinafter, also referred to as “USY (a)”) having a SiO₂/Al₂O₃ molar ratio of 5.2 and a Na₂O content of 0.60% by mass.

Next, 26.0 kg of the USY (a) was then suspended in 260 L of water having a temperature of 60° C. 61.0 kg of 25% sulfuric acid by mass was gradually added to the suspension, and then the suspension was stirred at 70° C. for 1 hour. The suspension was filtered. The resulting solid was washed with 260 L of deionized water having a temperature of 60° C. and dried at 130° C. for 20 hours, thereby producing an ultra stable zeolite Y (hereinafter, also referred to as “USY (b)”).

USY (b) was fired at 600° C. for 1 hour, thereby producing ultra stable zeolite Y (hereinafter, also referred to as “USY (c)”).

1 kg of USY (c) was then suspended in 10 L of water having a temperature of 25° C. The pH of the suspension was adjusted to 1.6 with 25% sulfuric acid by mass. Then 86 g of a solution containing 18% zirconium sulfate by mass and 45 g of a solution containing 18.33% titanium sulfate by mass was added thereto. The resulting mixture was stirred for 3 hours at room temperature. Then the pH was adjusted to 7.2 with 15% aqueous ammonia by mass. After the mixture was stirred for 1 hour at room temperature, the mixture was filtered. The resulting solid was washed with 10 L of water and dried at 130° C. for 20 hours, thereby producing about 1 kg of a titanium-zirconium-substituted zeolite (Ti-Zr-USY) (hereinafter, also referred to as “USY (A)”). Properties of USY (A) are further described in U.S. Pat. No. 10,293,332, the entirety of which is incorporated herein by reference.

### Example 1-2—Preparation of Catalyst Using Ammonia Passivation

First, 40 kg of an aqueous solution of 6.8% sodium aluminate by mass on an Al₂O₃ basis was mixed with 40 kg of an aqueous solution of 2.4% aluminum sulfate by mass on an Al₂O₃ basis. Further, the mixture was stirred at 60° C. for 1 hour, and then the product was washed with 150 L of a 0.3 mass % ammonia aqueous solution to remove Na₂SO₄. Next, water was added to the product from which Na₂SO₄ was removed to adjust an Al₂O₃ concentration to 10% by mass. The pH was adjusted to 10.5 with 15% aqueous ammonia by mass. The mixture was stirred at 95° C. for 10 hours, dehydrated, washed, and kneaded with a kneader, thereby producing an alumina mixture.

The USY (A) (Ti-Zr-USY zeolite) and the alumina mixture were mixed at a dry mass ratio of 3:7, and the mixture was kneaded. The mixture was formed into a columnar shape having a diameter of 1.8 mm, and fired at 550° C. for 3 hours, thereby producing a catalyst carrier. The catalyst carrier was passivated with ammonia by submerging the catalyst carrier in a solution comprising ammonia (NH₃) in water at a concentration of 8.5 wt. % for 1 hour and then dried at 110° C. for 12 hours.

An aqueous solution containing hydrogenative-active metal components was prepared by adding 580 mL of water to 240 g of molybdenum trioxide and 110 g of nickel carbonate. The aqueous solution containing hydrogenative-active metal components was added to the passivated catalyst carrier. The volume of the aqueous solution was equivalent to the approximate pore volume of the passivated catalyst carrier. The mixture was stirred at 95° C. for 5 hours, and then fired at 550° C. for 1 hour to obtain the catalyst, denoted as “Example 1”.

### Comparative Example A—Preparation of Comparative Catalyst without Ammonia Passivation

The cracking catalyst of Comparative Example A was prepared according to the method described in Example 1-2, with the exception that the catalyst carrier of Comparative Example A was not passivated with ammonia. That is, after forming the catalyst carrier, the catalyst carrier was mixed with the aqueous solution containing hydrogenative-active metal components, stirred at 95° C. for 5 hours, and then fired at 550° C. for 1 hour to obtain the comparative catalyst, denoted as “Comparative Example A”.

### Example 2—Characterization of the Catalysts of Example 1 and Comparative Example A

Textural properties of the catalysts of Example 1 and Comparative Example A were measured and are reported in Table 1. The amounts of metal oxides present in the catalysts are also reported in Table 1.

TABLE 1

| | | Comparative Example | |
|---|---|---|---|
| | | A | Example 1 |
| Surface Area | m²/g | 325 | 293 |
| Pore Volume | cm³/g | 0.58 | 0.63 |
| Silica-to-Alumina Ratio | — | 40 | 40 |
| MoO₃ | wt. % | 15.5 | 15.7 |
| NiO | wt. % | 3.8 | 3.9 |
| TiO₂ | wt. % | 0.13 | 0.15 |
| ZrO₂ | wt. % | 0.18 | 0.14 |

### Example 3—Hydrocracking a Vacuum Gas Oil Using the Catalysts of Example 1 and Comparative Example A

The catalysts were subjected to a hydrocracking test using a vacuum gas oil (VGO) feed oil having a density 0.923 g/cc, a sulfur content of 2.51 wt. %, and a nitrogen content of 960 ppm. The vacuum gas oil used in Example 3 had a boiling point profile according to Table 2, as measured by gas chromatography ASTMD2887.

TABLE 2

| | Temperature |
|---|---|
| Initial Boiling Point | 216° C. |
| 5 wt. % Boiling Point | 315° C. |
| 10 wt. % Boiling Point | 344° C. |
| 20 wt. % Boiling Point | 378° C. |
| 30 wt. % Boiling Point | 402° C. |
| 40 wt. % Boiling Point | 421° C. |
| 50 wt. % Boiling Point | 440° C. |
| 60 wt. % Boiling Point | 460° C. |
| 70 wt. % Boiling Point | 482° C. |
| 80 wt. % Boiling Point | 507° C. |
| 90 wt. % Boiling Point | 540° C. |
| 95 wt. % Boiling point | 565° C. |
| Final Boiling Point | — |

A pilot plant was loaded with 100 mL of a commercial pretreat catalyst followed by 100 ml of either the catalyst of Comparative Example A or the catalyst of Example 1. Pilot plant tests were conducted at a hydrogen partial pressure of 13.5 MPa, a hydrogen/oil ratio of 1,000 StL/L of oil, a LHSV of 0.50 hr-1, and reaction temperatures of 360, 375, 390, or 405° C. Table 3 shows a summary of the activity of the catalysts tested and product yields at 50 wt. % conversion of the VGO. As shown in Table 3, the catalyst of Example 1 required about 1° C. less temperature to obtain the same conversion of the VGO using the catalyst of Comparative Example A.

TABLE 3

| | | Comparative | | |
|---|---|---|---|---|
| | Unit | Example A | Example 1 | Delta |
| Temperature @ 50 W % | ° C. | 378.6 | 377.7 | −0.9 |
| Conversion | | | | |
| Gas (C1-C4) | wt. % | 1.3 | 1.1 | −0.2 |
| Naphtha (C5-145° C.) | wt. % | 5.6 | 7.6 | 1.9 |
| Kerosene (145° C.-260° C.) | wt. % | 26.0 | 24.0 | −2.0 |
| Gasoil (260° C.-360° C.) | wt. % | 24.1 | 24.3 | 0.2 |
| Middle Distillate | wt. % | 50.2 | 48.4 | −1.8 |
| (145° C.-360° C.) | | | | |
| Unconverted bottoms | wt. % | 42.9 | 42.9 | 0.1 |
| (360+ ° C.) | | | | |
| Total | | 100.0 | 100.00 | 0.0 |

Table 4 shows a summary of the activity of the catalysts tested and product yields at 380° C. As shown in Table 3, cracking the VGO using the catalyst of Example 1, that is passivating the Ti-Zr USY zeolite with ammonia prior to adding the hydrogenative metal components to the catalyst, resulted in an increase of 0.4% total conversion, and in increase in the selectivity of naphtha production (by approximately 2 wt. %) compared to cracking the VGO using the catalyst the catalyst of Comparative Example A.

TABLE 4

| | | Comparative | | |
|---|---|---|---|---|
| | Unit | Example A | Example 1 | Delta |
| Conversion @ 380° C. | % | 54.4 | 54.8 | 0.4 |
| Gas (C1-C4) | wt. % | 1.3 | 1.2 | −0.2 |
| Naphtha (C5-145° C.) | wt. % | 6.4 | 8.2 | 1.8 |
| Kerosene (145° C.-260° C.) | wt. % | 28.7 | 26.8 | −1.9 |
| Gasoil (260° C.-360° C.) | wt. % | 24.3 | 24.9 | 0.6 |
| Middle Distillate | wt. % | 53.1 | 51.7 | −1.4 |
| (145° C.-360° C.) | | | | |
| Unconverted bottoms | wt. % | 39.1 | 38.8 | −0.3 |
| (360+ ° C.) | | | | |

As described herein, the catalysts of Example 1 and Comparative Example A utilized in the hydrocracking reaction to crack the vacuum gas oil at a hydrogen partial pressure of 13.5 MPa, a hydrogen/oil ratio of 1,000 StL/L of oil, a LHSV of 0.50 hr⁻¹, and reaction temperatures of 360, 375, 390, or 405° C. An activation energy of the hydrocracking reactions was determined using Arrhenius plots, plotting 1/TR on the x-axis, where T=temperature (K) and R is the gas constant=1.987 cal K⁻¹ mol⁻¹, the negative slope is equal to the activation energy, and the natural logarithm of the rate constant (k) on the y-axis. The rate constant (k) was determined from the following equation:

$$- ln ( 1 - conversion / 100 ) \times LHSV$$

The calculated activation energies of the hydrocracking reactions utilizing the catalysts of Example 1 and Comparative Example A were 47.7 Kcal/mol and 59.6 Kcal/mol, respectively. That is, passivating the Ti-Zr-USY zeolite with ammonia prior to adding the hydrogenative-active metal components to the catalyst resulted in a decrease of the activation energy of a hydrocracking reaction utilizing the catalyst by about 20%.

A first aspect of the present disclosure is directed to a method of making a catalyst suitable for hydrocracking, the method comprising: contacting an initial catalyst with a passivation agent to form a passivated catalyst, wherein the initial catalyst comprises acid sites, and wherein the passivation agent binds to a portion or all of the acid sites on the initial catalyst; contacting the passivated catalyst with a metal precursor to form a doped catalyst, wherein the metal precursor comprises one or more metals, one or more metal salts, or both, the one or more metals, one or more metal salts, or combinations thereof comprising cobalt atoms, molybdenum atoms, nickel atoms, tungsten atoms, or combinations thereof; and heating the doped catalyst to form the catalyst, wherein: the catalyst comprises from 19.9 wt. % to 97.9 wt. % of a support material; from 2 wt. % to 80 wt. % of a zeolitic material comprising a microporous framework, wherein the microporous framework comprises zirconium oxide and titanium oxide; and from 0.1 wt. % to 40 wt. % of one or more metals, one or more metal oxides, or both, wherein the one or more metals are chosen from cobalt atoms, molybdenum atoms, nickel atoms, tungsten atoms, or combinations thereof, wherein the one or more metal oxides are chosen from cobalt oxide, molybdenum oxide, nickel oxide, tungsten oxide, or combinations thereof, and wherein the one or more metals, the one or more metal oxides, or both, are disposed on the microporous framework, the support material, or both.

A second aspect of the present disclosure may include the first aspect, further comprising making the initial catalyst, wherein making the initial catalyst comprises forming a catalyst precursor mixture comprising a support material and a zeolitic material.

A third aspect of the present disclosure may include the second aspect, wherein making the initial catalyst further comprises substituting alumina in a framework of an initial zeolite with zirconium, titanium, or both prior to forming the catalyst precursor mixture to form the zeolitic material.

A fourth aspect of the present disclosure may include either one of the second aspect or the third aspect, wherein making the initial catalyst further comprises: extruding the catalyst precursor mixture to form an extrudate; and calcining the extrudate to form the initial catalyst.

A fifth aspect of the present disclosure may include any one of the first through fourth aspects, wherein the passivation agent is chosen from a material having the formula R—NH₂, wherein R is a hydrocarbyl, a heterohydrocarbyl, hydrogen (H), an alkyl, or an aromatic moiety.

A sixth aspect of the present disclosure may include any one of the first through fifth aspects, wherein the passivation agent comprises ammonia.

A seventh aspect of the present disclosure may include any one of the first through sixth aspects, wherein contacting the initial catalyst with the passivation agent comprises contacting the initial catalyst with a passivation solution that comprises the passivation agent, wherein the passivation solution comprises the passivation agent at a concentration of greater than or equal to 1 wt. % and less than or equal to 30 wt. %.

An eighth aspect of the present disclosure may include any one of the first through seventh aspects, wherein the metal precursor comprises a metal solution comprising cobalt atoms, molybdenum atoms, nickel atoms, tungsten atoms, or combinations thereof.

A ninth aspect of the present disclosure may include any one of the first through eighth aspects, wherein the heating of the doped catalyst is at a temperature of at least 500° C. such that the doped catalyst is calcined.

A tenth aspect of the present disclosure may include any one of the first through ninth aspects, wherein when the catalyst is utilized in a hydrocracking reaction to crack vacuum gas oil, the activation energy of the hydrocracking reaction is less than or equal to 55 Kcal/mol, wherein the vacuum gas oil has an initial boiling point of from 205° C. to 225° C. and a 95 wt. % boiling point of from 555° C. to 575° C., and the ratio of hydrogen to vacuum gas oil is 1,000 StL/L.

An eleventh aspect of the present disclosure may include any one of the first through tenth aspects, wherein the zeolitic material comprises from 0.1 wt. % to 5 wt. % of the zirconium oxide.

A twelfth aspect of the present disclosure may include any one of the first through eleventh aspects, wherein the zeolitic material comprises from 0.1 wt. % to 5 wt. % of the titanium oxide.

A thirteenth aspect of the present disclosure may include any one of the first through twelfth aspects, wherein the zeolitic material comprises from 0.1 wt. % to 5 wt. % of the zirconium oxide, and from 0.1 wt. % to 5 wt. % of the titanium oxide.

A fourteenth aspect of the present disclosure may any one of the first through thirteenth aspects, wherein the zeolitic has a crystal lattice constant of from 2.430 nm to 2.450 nm.

A fifteenth aspect of the present disclosure may include any one of the first through fourteenth aspects, wherein the zeolitic material has a specific surface area of 600 m²/g to 900 m²/g.

A sixteenth aspect of the present disclosure may include any one of the first through fifteenth aspects, wherein the support material comprises an inorganic oxide excluding the zeolitic material comprising the microporous framework.

A seventeenth aspect of the present disclosure may include any one of the first through sixteenth aspects, wherein the catalyst comprises an ultra-stable zeolite Y.

An eighteenth aspect of the present disclosure may include any one of the first through seventeenth aspects, wherein the catalyst has a volume of pores having a diameter of less than or equal to 600 Å from 0.40 mL/g to 0.75 mL/g.

A nineteenth aspect of the present disclosure is directed to a catalyst suitable for hydrocracking, made by any one of the first through eighteenth aspects.

A twentieth aspect of the present disclosure may include the nineteenth aspect, wherein when the catalyst is utilized in a hydrocracking reaction to crack vacuum gas oil, the activation energy of the hydrocracking reaction is less than or equal to 55 Kcal/mol, wherein the vacuum gas oil has an initial boiling point of from 205° C. to 225° C. and a 95 wt. % boiling point of from 555° C. to 575° C., and the ratio of hydrogen to vacuum gas oil is 1,000 StL/L.

The subject matter of the present disclosure has been described in detail and by reference to specific embodiments. It should be understood that any detailed description of a feature of an embodiment does not necessarily imply that the feature is essential to the particular embodiment or to any other embodiment. Further, it should be apparent to those skilled in the art that various modifications and variations can be made to the described embodiments without departing from the spirit and scope of the claimed subject matter.

For the purposes of describing and defining the present disclosure it is noted that the terms “about” or “approximately” are utilized in this disclosure to represent the inherent degree of uncertainty that may be attributed to any quantitative comparison, value, measurement, or other representation. The terms “about” and/or “approximately” are also utilized in this disclosure to represent the degree by which a quantitative representation may vary from a stated reference without resulting in a change in the basic function of the subject matter at issue.

It should be understood that any two quantitative values assigned to a property may constitute a range of that property, and all combinations of ranges formed from all stated quantitative values of a given property are contemplated in this disclosure.

It is noted that one or more of the following claims utilize the term “wherein” as a transitional phrase. For the purposes of defining the present technology, it is noted that this term is introduced in the claims as an open-ended transitional phrase that is used to introduce a recitation of a series of characteristics of the structure and should be interpreted in like manner as the more commonly used open-ended preamble term “comprising.” It should be understood that where a first component is described as “comprising” a second component, it is contemplated that, in some embodiments, the first component “consists” or “consists essentially of” that second component. The transitional phrase “consisting of” excludes any element, step, or ingredient not specified in the claim, and the transitional phrase “consisting essentially of” is a limitation to the specified materials or steps and those that do not materially affect the basic and novel characteristics of the claimed embodiment.

What is claimed is:

1. A method of making a catalyst suitable for hydrocracking, the method comprising:
contacting an initial catalyst with a passivation agent to form a passivated catalyst, wherein the initial catalyst comprises acid sites, and wherein the passivation agent binds to a portion or all of the acid sites on the initial catalyst;
contacting the passivated catalyst with a metal precursor to form a doped catalyst, wherein the metal precursor comprises one or more metals, one or more metal salts, or both, the one or more metals, one or more metal salts, or combinations thereof comprising cobalt atoms, molybdenum atoms, nickel atoms, tungsten atoms, or combinations thereof; and
heating the doped catalyst to form the catalyst;
wherein the catalyst comprises:
from 19.9 wt. % to 97.9 wt. % of a support material;
from 2 wt. % to 80 wt. % of a zeolitic material comprising a microporous framework, wherein the microporous framework comprises zirconium oxide and titanium oxide; and
from 0.1 wt. % to 40 wt. % of one or more metals, one or more metal oxides, or both, wherein the one or more metals are chosen from cobalt atoms, molybdenum atoms, nickel atoms, tungsten atoms, or combinations thereof, wherein the one or more metal oxides are chosen from cobalt oxide, molybdenum oxide, nickel oxide, tungsten oxide, or combinations thereof, and wherein the one or more metals, the one or more metal oxides, or both, are disposed on the microporous framework, the support material, or both.

2. The method of claim 1, further comprising making the initial catalyst, wherein making the initial catalyst comprises forming a catalyst precursor mixture comprising a support material and a zeolitic material.

3. The method of claim 2, wherein making the initial catalyst further comprises substituting alumina in a framework of an initial zeolite with zirconium, titanium, or both prior to forming the catalyst precursor mixture to form the zeolitic material.

4. The method of claim 2, wherein making the initial catalyst further comprises:
extruding the catalyst precursor mixture to form an extrudate; and
calcining the extrudate to form the initial catalyst.

5. The method of claim 1, wherein the passivation agent is chosen from a material having the formula R—NH₂, wherein R is a hydrocarbyl, a heterohydrocarbyl, hydrogen (H), an alkyl, or an aromatic moiety.

6. The method of claim 1, wherein the passivation agent comprises ammonia.

7. The method of claim 1, wherein contacting the initial catalyst with the passivation agent comprises contacting the initial catalyst with a passivation solution that comprises the passivation agent, wherein the passivation solution comprises the passivation agent at a concentration of greater than or equal to 1 wt. % and less than or equal to 30 wt. %.

8. The method of claim 1, wherein the metal precursor comprises a metal solution comprising cobalt atoms, molybdenum atoms, nickel atoms, tungsten atoms, or combinations thereof.

9. The method of claim 1, wherein the heating of the doped catalyst is at a temperature of at least 500° C. such that the doped catalyst is calcined.

10. The method of claim 1, wherein when the catalyst is utilized in a hydrocracking reaction to crack vacuum gas oil, the activation energy of the hydrocracking reaction is less than or equal to 55 Kcal/mol, wherein the vacuum gas oil has an initial boiling point of from 205° C. to 225° C. and a 95 wt. % boiling point of from 555° C. to 575° C., and the ratio of hydrogen to vacuum gas oil is 1,000 StL/L.

11. The method of claim 1, wherein the zeolitic material comprises from 0.1 wt. % to 5 wt. % of the zirconium oxide.

12. The method of claim 1, wherein the zeolitic material comprises from 0.1 wt. % to 5 wt. % of the titanium oxide.

13. The method of claim 1, wherein the zeolitic material comprises from 0.1 wt. % to 5 wt. % of the zirconium oxide, and from 0.1 wt. % to 5 wt. % of the titanium oxide.

14. The method of claim 1, wherein the zeolitic has a crystal lattice constant of from 2.430 nm to 2.450 nm.

15. The method of claim 1, wherein the zeolitic material has a specific surface area of 600 m²/g to 900 m²/g.

16. The method of claim 1, wherein the support material comprises an inorganic oxide excluding the zeolitic material comprising the microporous framework.

17. The method of claim 1, wherein the catalyst comprises an ultra-stable zeolite Y.

18. The method of claim 1, wherein the catalyst has a volume of pores having a diameter of less than or equal to 600 Å from 0.40 mL/g to 0.75 mL/g.

19. A catalyst suitable for hydrocracking made by the method of claim 1.

20. The catalyst of claim 19, wherein when the catalyst is utilized in a hydrocracking reaction to crack vacuum gas oil, the activation energy of the hydrocracking reaction is less than or equal to 55 Kcal/mol, wherein the vacuum gas oil has an initial boiling point of from 205° C. to 225° C. and a 95 wt. % boiling point of from 555° C. to 575° C., and the ratio of hydrogen to vacuum gas oil is 1,000 StL/L
